(19) United States
(12) Patent Application Publication
(10) Pub. No.: US 2006/0196069 A1
(43) Pub. Date: Sep. 7, 2006

(54) Picture Frame Hardware Mounting Aid

(76) Inventor: William Ryan Groepper, La Jolla, CA (US)

Correspondence Address: Ryan Groepper, 7330 B Fay Ave, La Jolla, CA, 92037, US

(21) Appl. No.: 11/307,025

(22) Filed: Jan. 19, 2006

Related U.S. Application Data
(60) Provisional application No. 60/645,528, filed on Jan. 20, 2005.

(51) Int. Cl. G01D 21/00

(52) U.S. Cl. 33/613

(57) ABSTRACT

A device for marking the optimal placement of a picture hanging nail, or the like, on a wall when positioning a picture, or similar object, is disclosed. The inventive device includes a magnetic marking tip for use with smaller picture hanging hardware such as sawtooth hangers, D-rings, triangle hangers and other metal hangers, and a wire adapter device for providing tension on cord based hanger, as typically found on larger picture frames and mirrors. The marking tip attaches to the wire adapter, and comprises a magnet with a coaxially-aligned marker and a projecting tip attached to the opposite sides of the magnet. The wire adapter comprises three pieces: an upper member that is frictionally affixed to the top rear of a picture frame that has a cord hanger, a lower member with a hook to retain the cord hanger, a hole on the hook to receive the marking tip, and a strap for retaining the upper and lower members together and capable of providing tension on the cord in order to position the cord to correspond with a final position when the cord is suspended on a wall-mounted nail or other hardware.

### PRIORITY CLAIM

This patent application claims the benefit of U.S. Provisional Application 60/645,528, filed on Jan. 20, 2005.

### FIELD OF THE INVENTION

The present invention relates generally to a picture positioning device, and more specifically to a device for marking the optimal location for installing picture hanging hardware such as a nail, picture hook, or similar device.

### DESCRIPTION OF THE RELATED ART

The process of hanging a picture on a wall can be exceptionally frustrating. Pictures, artwork, mirrors and similar objects designed to be hung on a wall typically use one of several available means to support the object upon a nail or hook that is fastened to the wall. For example, several prior art means of supporting such an object include a cord which is strung across the back of a frame of the object, hanging hardware specifically designed for the task, such as a sawtooth or triangle hanger, or a D-ring attached to the back of the object. As the back of the object is out of sight when placement of the picture on the wall is considered, it is therefore very difficult to determine the precise location to install a nail or picture hook such that the picture is suspended in the desired location. Thus, hanging a picture in the desired location often results in a trial-and-error process that produces multiple unwanted holes in the wall until happening on the correct position, or simply settling for a picture position that is “close enough”.

While it can be appreciated that picture positioning devices have been known for years, there is substantial room for improvement. The main problem with conventional picture positioning devices is that no single product provides a system for all types of hanging needs that is simple to use, inexpensive to manufacture, is reusable and allows for intuitive picture placement.

Typically, picture positioning devices are comprised of a variety of products that are designed to assist in hanging a frame with a wire hanger or are designed to assist in hanging a frame with a sawtooth hanger.

Another problem with conventional picture positioning devices is that they are overly complex and prohibitively expensive to manufacture. Another problem with conventional picture positioning devices is that they are often unwieldy to operate, and too large to be sold in the typical picture frame section of a retail store. Many of these devices require the user to support the entire weight of the picture frame from the device as the user attempts to find the desired location, which is an unreasonable expectation for larger frames or for many people.

Other devices may work suitably with a common sawtooth hanger, but would not accurately function with the also common triangle and D-ring hanging hardware.

Representative examples of such prior art devices include those described in the following patents:

| Pub. Number | Inventor | Publication Date |
|---|---|---|
| 2004098875 | Gould | May 27, 2004 |
| A1 | | |
| 6,978,551 | Krake | Dec. 27, 2005 |
| 6,971,184 | Prevost | Dec. 6, 2005 |
| 6,957,797 | Strobel | Oct. 25, 2005 |
| 6,883,244 | Rimback | Apr. 26, 2005 |
| 6,739,065 | Hofmeister et | May 25, 2004 |
| | al. | |
| 6,513,780 | Cox | Feb. 4, 2003 |
| 6,185,831 | Pluciennik | Feb. 13, 2001 |
| 6,070,847 | Kirchner | Jun. 6, 2000 |
| 6,049,991 | Gruenberg et | Apr. 18, 2000 |
| | al. | |
| 6,029,362 | Miodragovic | Feb. 29, 2000 |
| 6,026,584 | Wegman | Feb. 22, 2000 |
| 5,867,917 | Karon | Feb. 9, 1999 |
| 5,509,213 | Kelly et al. | Apr. 23, 1996 |
| 5,471,760 | Farris | Dec. 5, 1995 |
| 5,180,135 | Hindall | Jan. 19, 1993 |
| 5,129,154 | Aydelott | Jul. 14, 1992 |
| 5,109,611 | Houck | May 5, 1992 |
| 5,103,573 | Ehling et al. | Apr. 14, 1992 |
| 4,893,776 | Floyd | Jan. 16, 1990 |
| 4,648,185 | Brandimarte | Mar. 10, 1987 |
| 4,637,583 | Babitz | Jan. 20, 1987 |
| 4,559,690 | Asm | Dec. 24, 1985 |
| 4,512,084 | Lieberman | Apr. 23, 1985 |
| 4,485,561 | Hopkins, Sr. | Dec. 4, 1984 |
| 4,473,957 | Faulkner | Oct. 2, 1984 |
| 4,443,949 | Newton | Apr. 24, 1984 |
| 4,413,421 | Siniuk | Nov. 8, 1983 |
| 4,382,337 | Bendick | May 10, 1983 |
| 4,241,510 | Radecki | Dec. 30, 1980 |
| 3,516,165 | Pfeffer | Jun. 23, 1970 |

All of the prior art devices represented by the above patents include some means of marking a wall at the location where a nail, hook, or other hardware should be placed on the wall. However, all of these devices have the drawback that they only work with one specific type of picture frame hanging apparatus, most typically a cord-based hanging system. The next most common picture frame hanging device is a sawtooth bracket mounted to the picture frame.

U.S. Pat. No. 6,000,142 to Deaton on Dec. 14, 1999 teaches a device that does work with both cord-based hanging systems as well as the next most commonly used sawtooth bracket. However, this device has several drawbacks. For example, the locator blocks 2 and 12 of the invention are separate elements, one that works with cord-based hanging systems and the other working with sawtooth brackets. As such, these elements are essentially separate products, and can easily become separated from each other if both elements are sold together as a kit. Indeed, these are each described in the—142 patent as separate embodiments. Moreover, the tacks used with such an invention rely on pressure applied to the picture in order to mark the wall. Not only can excessive pressure permanently indent canvas material and fine artwork, thereby damaging same, a simple tack mark in a wall is often difficult to locate once the picture and the device have been removed from the wall. Moreover, the block element for use with sawtooth hangers may not exactly mark the correct location, or even work with all sawtooth hangers as the depth and height of various sawtooth hangers differ. Further, the marking element can slide out of position if the frame is tilted during the hanging process.

Likewise, U.S. Pat. No. 6,952,887 to Muchnik on Oct. 11, 2005 teaches a system having multiple embodiments of a marking implement used on pictures or frames having different hanging hardware. An embodiment for use with sawtooth or other mounting brackets is show in FIGS. 7-9, and an alternate embodiment for use with hanging wire type hardware is shown in FIG. 23. There is no suggestion to combine these embodiments into one device so that the user carries only one implement. Further, the sawtooth bracket embodiment show in FIGS. 7-9 is overly complex, and therefore relatively expensive to manufacture. While such a device may function to achieve its stated objectives principally of allowing the marking device to be slid along a wall without inadvertent marking thereof, to use such a device with a variety of picture frame mounting hardware types requires the user to carry multiple embodiments around from frame to frame.

What is needed, therefore, is a wall marking device that is easy to use with both wire hanging and sawtooth bracket type picture hanging hardware interchangeably. Such a needed device would be combined in one product, so that the various elements thereof would remain together even during storage and transport. Such a needed device would be simple to use and relatively inexpensive to manufacture, and would allow marking of the wall at the desired location without the need to press the picture canvas itself with much force. Further, such a needed device would be reusable. The present invention fulfills these requirements.

### SUMMARY OF THE INVENTION

In view of the foregoing disadvantages inherent in the known types of picture positioning device described in the prior art, the present invention provides a new device for marking the optimal location on a wall for installing a nail, picture hook, or similar hardware to correspond perfectly to the desired placement when positioning a picture, or similar object for hanging on the wall.

The general purpose of the present invention, which will be described subsequently in greater detail, is to provide a new device for marking the optimal placement of a picture hanger that has many of the advantages of the picture positioning device mentioned heretofore and many novel features that result in a new device for marking the optimal placement of a picture hanger which is not anticipated, rendered obvious, suggested, or even implied by any of the prior art picture positioning device, either alone or in any combination thereof

To attain this, the present invention generally comprises a magnetic marking tip for use with smaller picture hanging hardware such as sawtooth hangers, D-ring and triangle hangers, and other metal hangers, and a wire adapter device for providing tension on cord based hangers, as typically found on larger picture frames and mirrors, and to which the marking tip attaches. The marking tip comprises a magnet with a coaxially aligned marker and a projecting guide tip attached to opposite sides of the magnet. When hanging frames with the smaller picture hanging hardware the marking tip can be used alone to locate the installation location, where frames with a cord hanger require the use of the wire adapter. The wire adapter comprises three pieces: an upper member that is frictionally affixed to the top of a picture frame with a cord based hanger, a cord tensioning member with an aperture positioned to optimally receive the marking tip, and a line or strap retaining the upper and lower members capable of providing tension to the cord.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a device for marking the optimal placement of a picture hanger that will overcome the shortcomings of the prior art devices.

An object is to provide a device for marking the optimal placement of a picture hanger that is used in marking a precise point on a wall where a fastener should be installed to hang an object at the desired location.

Another object is to provide a device for marking the optimal placement of a picture hanger that can be attached to a wide variety of picture hanging hardware such as, sawtooth hangers, D-ring hangers, triangle hangers, wall sconces, and other metal hanging hardware.

Another object is to provide a device for marking the optimal placement of a picture hanger that can also be used as a system when installing an object with a wire or cord hanger by tensioning said cord to simulate hanging tension and enable locating the precise point on the wall where a fastener should be installed.

Another object is to provide a device for marking the optimal placement of a picture hanger that is cost effective to manufacture and is conveniently sized for promotion within a retail store environment.

Another object is to provide a device for marking the optimal placement of a picture hanger that is intuitive and simple to use.

Another object is to provide a device for marking the optimal placement of a picture hanger that is reusable.

Another object is to provide a device for marking the optimal placement of a picture hanger that does not permanently damage the walls.

Other objects and advantages of the present invention will become clear, and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a perspective view of the present invention.

FIG. 2 is a side view of a marker tip.

FIG. 3 is a perspective view of both upper and lower member of the present invention.

FIG. 4 is a perspective view of the marker tip, illustrating a projecting tip thereof.

FIG. 5 is a perspective view of the marker tip.

FIG. 6 is a rear view of the marker tip.

FIG. 7 is a front view of the marker tip.

### DETAILED DESCRIPTION OF THE INVENTION

Turning now to the drawings, in which similar reference characters denote similar elements throughout the several views, the attached figures illustrate a device for marking the optimal placement of a picture hanger. The device comprises a magnetic marking tip 5 for use with smaller picture hanging hardware such as sawtooth hangers, D-rings, triangle hangers and other metal hangers, and a wire adapter 7 device for providing tension on wire hangers 70, as typically found on larger picture frames 80 and mirrors, and to which the marking tip 5 attaches. The marking tip 5 comprises magnet 10 with a coaxially aligned marker 20 and a projecting tip 30 attached to opposite upper and lower sides of the magnet 10. The wire adapter 7 comprises three pieces: an upper member 40 that includes an L-shaped bracket that is frictionally affixed to the top of a picture frame 80 having a cord hanger 70, a lower member 50 having a J-shaped bracket with a hole 52 positioned to optimally receive the projecting tip 30 of the marking tip 5, and a line or strap 60 retaining the upper 40 and lower 50 members together and capable of providing tension to the cord hanger 70 when the upper member is engaged to a top edge of the picture frame 80. Preferably the marker, magnet, and projecting tip are all circular in cross-section, and the projecting tip is no larger in diameter than a standard picturing hanging nail, such as 1/32 of an inch, for example.

The marking tip 5 comprises magnet 10 with a coaxially aligned marker 20 and a projecting tip 30 attached to opposite upper and lower sides of the magnet 10 such that the marking tip 5 may affix magnetically to the back of most metallic picture hanging hardware or, alternately, to the specialized wire adapter 7. On the side of the magnet 10 facing the frame 80 protrudes a projecting tip 30. The tip 30 aligns the marking tip 5 optimally with the picture hanging hardware that is mounted on the frame 80. As such, the tip 30 fits into such hardware as would a nail or other such mounting hardware. On the wall-facing side of the magnet 10, or upper side, protrudes a marker 20 or similar device coaxially aligned with the projecting tip 30. As such, the user is able to position the picture frame 80 on the wall in the desired location and gently move the frame 80 closer to the wall. In the preferred embodiment, an erasable mark is left on the wall, indicating precisely where to install a nail, or picture hook type device. Other variations on the marking tip 5 include replacing the marker 20 with a dense pointed tip designed to indicate the installation position by leaving an indent in the wall. In another variation, the magnet 10 is replaced or supplemented by an adhesive material (not shown). In another variation, the projecting tip 30 may be eliminated altogether, the marking tip 5 being aligned to the mounting hardware by eye.

The wire adapter 7 comprises three pieces: an upper member 40 that includes an L-shaped bracket that is frictionally affixed to the top of a picture frame 80, a lower member 50 that comprises a J-shaped bracket forming a hook 51 for retaining the cord hanger 70, and a line or strap 60. The lower member 50 further includes a hook tab 54 containing a hole 52 positioned to optimally receive the marking tip 5, and the strap 60 retaining the upper 40 and lower 50 members together and capable of providing tension to the cord hanger 70.

The upper member 40 comprises an L-shaped bracket allowing removable positioning over a top rear peripheral surfaces of the picture frame 80, and in the preferred embodiment includes a friction increasing material 42 applied to the top frame-contacting surface of the upper member 40 (FIG. 3). The lower member 50 comprises a cord engaging hook 51 for engaging the cord hanger 70 and moving the cord 70 to a tensioned position, such as it assumes when it is disposed over a yet-to-be-installed picture hanging hardware device, such as a nail (not shown). The cord engaging hook 51 comprises a metal surface with an aperture 52 corresponding to the nail location relative to the cord hanger 70 when the picture frame is suspended from the nail on a wall, for example.

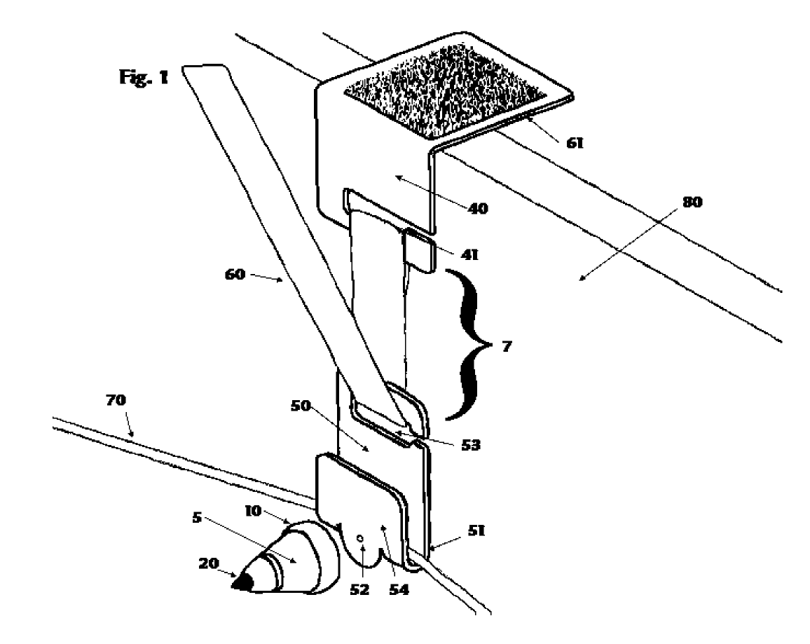

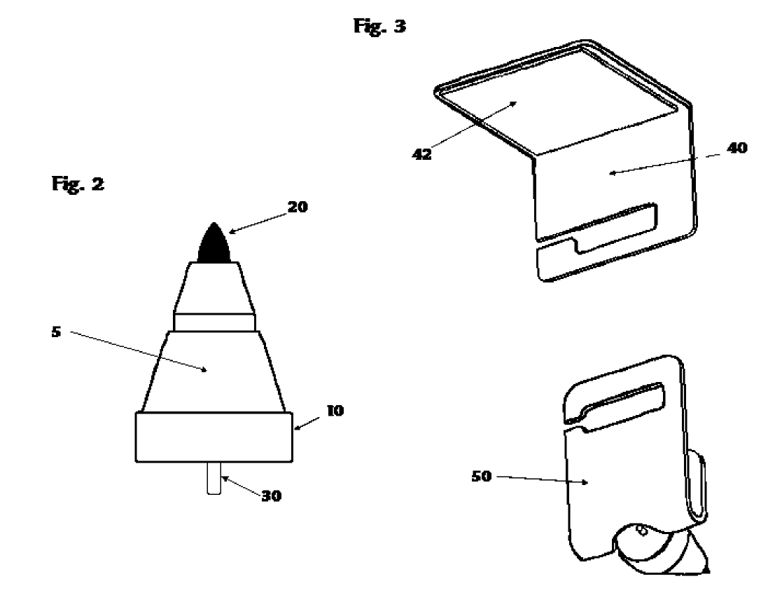

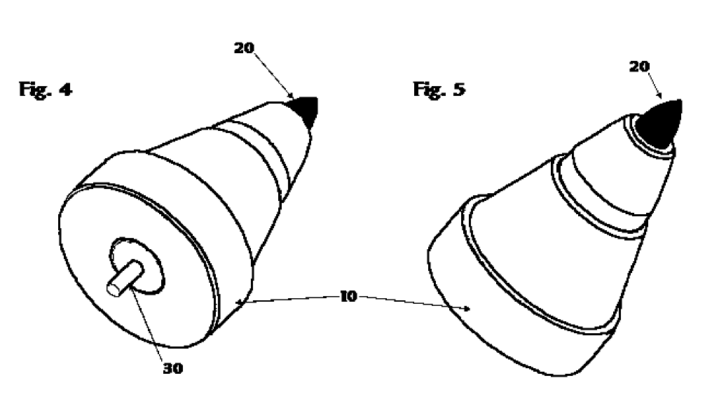

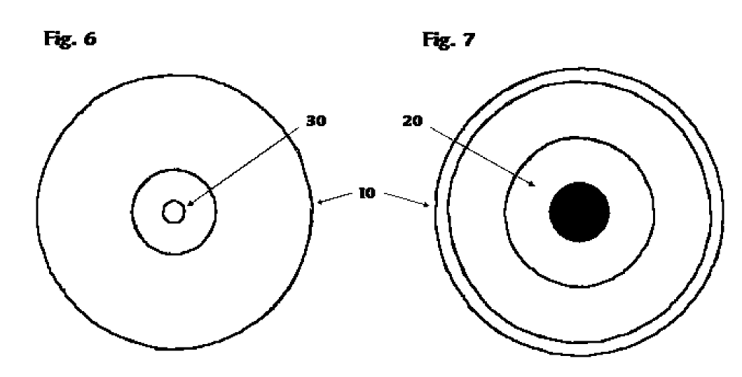

In the preferred embodiment, a strap attachment means for attaching the strap 60 from the upper member 40 to the lower member 50 is a hook-and-loop type strap 60 that is adjustably tensionable. The upper member has a notch 41 for receiving the strap 60, and the lower member likewise has a notch 53 for receiving the strap 60 (FIG. 1). As tension is applied to position the cord hanger 70 in a fully tensioned position, said hook and loop strap 60 is affixed to the upper member 40 by contacting the corresponding hook and loop material 61 applied to a top facing side of the upper member 40 (FIG. 1). The marking tip 5 is attached to the wire hanger 7 by positioning the projecting tip 30 through lower member 50 aperture 52. Other variations of the wire adapter 7 may include other tensioning means, including but not limited to a spring or elastic or non-elastic lines, and any variety of friction producing notches, grooves or slots to secure said strap 60 in a tensioned position.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A device for aiding in the mounting of a picture frame on a wall, the picture frame having at least one metallic mounting bracket on a back side thereof for engaging a nail, the device comprising:
a marking tip having a magnet with an upwardly protruding marker on a top side thereof and a downwardly projecting tip on a bottom side thereof, the projecting tip being coaxially aligned with the marker;
whereby with the tip engaged with the metallic bracket of the picture frame at a location corresponding to the location of the nail, and the magnet magnetically attached to the metallic bracket, the frame may be positioned against the wall at a desired location such that the marker marks the wall at a proper location for driving the nail into the wall for the nail to hold the picture frame at the desired location.

2. The device of claim 1 wherein the magnet and the projecting tip are both cylindrical, and wherein the base of the marker is circular.

3. The device of claim 1 wherein the projecting tip is of a diameter no larger than the diameter of the nail.

4. The device of claim 1 further including a wire adapter for aiding in the mounting of the picture frame on the wall wherein the picture frame includes a hanging wire on the back side thereof, the wire adapter comprising:
an upper member comprising a generally L-shaped bracket for engaging a top edge of the frame, the upper member including a strap attachment means;
a lower member comprising a generally J-shaped bracket for engaging the hanging wire of the picture frame therein, the lower member including a strap attachment means and a marker tip attachment hole adapted to receive the projecting tip of the marker tip; and
a strap for adjustably selecting the distance between the upper and lower members, the strap attached to each of the upper and lower members at their respective strap attachment means;
whereby with the upper member hooked over a top portion of the picture frame and the lower member engaged with the hanging wire of the picture frame, and with the marker tip fixed to the lower member, the strap may be selectively shortened such that the hanging wire is placed under tension and the frame may then be positioned against the wall at a desired location such that the marker marks the wall at a proper location for driving the nail into the wall for the nail to hold the picture frame at the desired location by the tensioned hanging wire.

5. The device of claim 4 wherein the strap attachment means of both upper and lower members is a lateral notch therein for receiving a loop of the strap.

6. The device of claim 5 further including a hook-type fastening material fixed on a top side of the L-shaped bracket, and wherein the strap is a loop-type fastening material, whereby the strap may be pulled and fixed at a selected location, thereby fixing the distance between the upper and lower members and providing a substantially constant tension on the hanging wire.
